(19) United States
(12) Patent Application Publication
(10) Pub. No.: US 2006/0089858 A1
(43) Pub. Date: Apr. 27, 2006

(54) Means and method of applying RFID and PKI technologies for patient safety

(76) Inventor: Tun Ling, Taipei City (TW)

Correspondence Address: HDSL, 4331 STEVENS BATTLE LANE, FAIRFAX, VA, 22033, US

(21) Appl. No.: 10/970,999

(22) Filed: Oct. 25, 2004

(51) Int. Cl. G06Q 10/00

(52) U.S. Cl. 705/2

(57) ABSTRACT

A system and a method for applying RFID (Radio Frequency Identification) and PKI (Public Key Infrastructure) technologies for patient health safety to install RFID tag and RFID reader on the medicine-storing appliance. By sensing the RFID tag on medicine, the RFID reader stores the medical records such as medicine usage and movement, and transmit to central database. In this way, the circulation of medicine could be controlled, the improper use and distribution of medicines could be avoided, the medical resource management could be improved, and it could ensure that the correct medicine to enhance the process of five rights (right time, right route, right dose, right patient and right drug) and improve the quality of patient safety.

### BACKGROUND OF THE INVENTION

1. Field of the Invention

The invention relates a system and a method for applying RFID (Radio Frequency Identification) and PKI (Public Key Infrastructure) technologies for patient health safety.

2. Description of the Prior Art

For a long time, to improve patient safety is the goal that every medical institute tries to accomplish. Patients' identification and the safety of medicine usage have been the focus by populace because of the medical error made by human such as giving incorrect doses or medicine. As the improvement of the modern technology, the development of medical information system has been closely combined with clinical decision-making support. At the same time, it is essential to provide instant and correct information to medical professionals by utilizing information system combining with relative professional domains, furthermore, to reduce medical error and improve the quality of medical care. To reduce the chances of taking wrong medicine and improve the quality of medicine utilization, several systems such as prescription transmit system, UDDS, and drug interaction system has been gradually developed in hospitals now. It is an important link in hospital management as how to manage medicines correctly and efficiently.

To provide a way to manage medicines, a hospital must be equipped with impeccable institution and approach. The current medicine management systems, except hospital existing system or recording medicine information and quality by hand, most of the others are attaching optical barcode on the bottle or box to record the information and quality. For example, an optical barcode with the information of a medicine is attached to that medicine just purchased. Then, the physician prescribes the medicine by using the barcode; pharmacist gets the barcode information with optical reader and dispenses the medicine. When it comes to check the stock of a medicine item, the computer will look into the database and list out related information for further actions after inputting the barcode of that item.

The disadvantage of the current managing and indexing systems of medicine is incomplete information content (most of the information is listed quantity and type). Because the information saved by barcode is limited (the capacity of one-dimension barcode is 50 bytes), medical personal can only get the basic information of that medicine item retrieved from barcode and no further information (e.g. can only get the Chinese and English name of that medicine). Since no other information is provided to verify the correctness of the information, major medical errors happened often that patients are given wrong doses, prescription or medicines. Barcode cannot be changed or reused once it is printed, therefore it happens that there are still pills in the bottle but don't know how many left. In that, there are some controlled drugs such as anesthetics and sedatives are improperly released or sold to bandit, which is the major loophole in hospital management, demolishing the reputation of the hospital, and wasting medical resources.

From this point of view, the current medicine management system still exists many disadvantages and needs improvement.

Based on the defects described above, it takes several years of research for the inventor of this case to contrive this system and method for medicine management.

### SUMMARY OF THE INVENTION

The present invention is to provide a way to utilize the system and method for applying RFID and PKI technologies for patient safety. By installing the RFID reader and RFID tags on the appliance where stored medicines, the goals of monitoring medicine stock, managing medicine information, quality and its distribution and preventing improper use or release of medicines could be meet.

Furthermore, the present invention is to apply PKI technologies for monitoring the management of medical resources. Medical staffs and patients are giving different identification means, with the undeniable characteristics of PKI technologies during the process of identity authentication and digital signature, to monitor the diagnosis/or treatment done by medical staffs and the usage of medicine, then prevent the improper use of medicines.

Still further, this invention is to improve the management of medicine resources. The system save the information of diagnosis/or treatment, usage or distribution of medicines and so on to database, which aids management staffs to monitor the information such as condition, quantity, distribution process or shortage of medicines.

The invention meets the purposes described above by installing an RFID tag and an RFID reader on medicine-storing appliances. After reading RFID tags on medicines, the RFID reader saves and transmits medical records such as the usage and location of medicines to database to control the distribution of medicines. Medical staffs and patients would have different identification devices. Whenever medical staffs are going to bedside for treatments or retrieve medicines, according to the technologies of RFID and PKI, they need to go through personal identification, medicine verification, identity authentication and digital signature to confirm the prescribed medicines as well as their users and to record the undeniable nature of the process. Using the computer, the information of diagnosis/treatment process, medicine usage and their distribution would be stored to database, which aids the personnel of hospital management to control the status of medicine usage. At the same time, the usage, information, quantity, distribution process or shortage of medicines would be monitored/traced to prevent improper use and release of medicines, to improve management of medicine resources, and also cam reconfirm the right medicine are used to the right patient.

### BRIEF DESCRIPTION OF THE DRAWINGS

The drawings disclose an illustrative embodiment of the present invention which serves to exemplify the various advantages and objects hereof, and are as follows:

FIG. 1 illustrates the system of the invention.

FIG. 2 illustrates the allocation of the system of the invention in a hospital.

FIG. 3 indicates the action flowchart of medicines at pharmacy terminal of this invention.

FIG. 4 indicates the action flowchart at physician terminal of the invention.

FIG. 5 indicates the action flowchart of retrieving medicine at nurse station terminal retrieves medicine of this invention.

FIG. 6 indicates the action flowchart of injecting/distributing medicine at nurse station terminal of the invention.

FIG. 7 indicates the action flowchart of reclaiming empty medicine box at nurse station terminal of the invention.

FIG. 8 indicates the action flowchart of exchanging empty medicine box at pharmacy terminal of the invention.

FIG. 9 illustrates the structure of the electronic medicine cabinet of the invention.

FIG. 10 illustrates the structure of the electronic medicine chest of the invention.

FIG. 11 illustrates the structure of the electronic medicine-reclaiming chest of the invention.

FIG. 12 illustrates the structure of the electronic medicine box of the invention.

FIG. 13 illustrates an implementation of the electronic medicine box of the invention.

FIG. 14 illustrates another implementation of the electronic medicine box of the invention.

### DETAILED DESCRIPTION OF THE PREFERRED EMBODIMENT

To let the examiners further understand the structure, utilization and characteristics of the invention, the inventor presents a better embodiment with figures and detailed description as follows:

The invention is the devices and methods for applying RFID (Radio Frequency Identification) and PKI (Public Key Infrastructure) technologies on health safety. It manages the status of medicine distribution, stores, and records medicine used during treatment by reading the information on RFID tag, which then assists medicine management staff to monitor medicine information, quantity and circulation process.

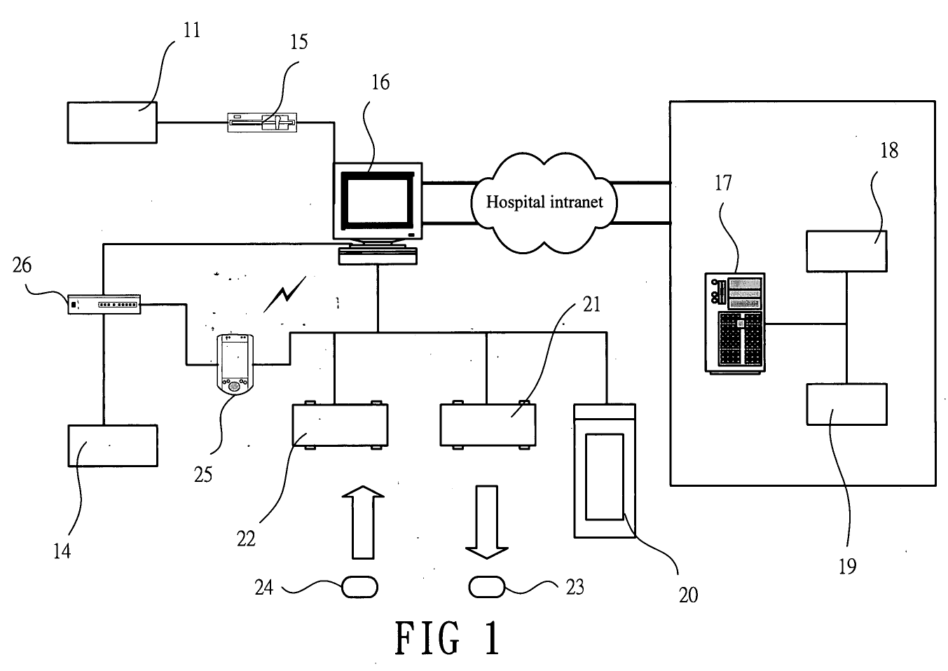

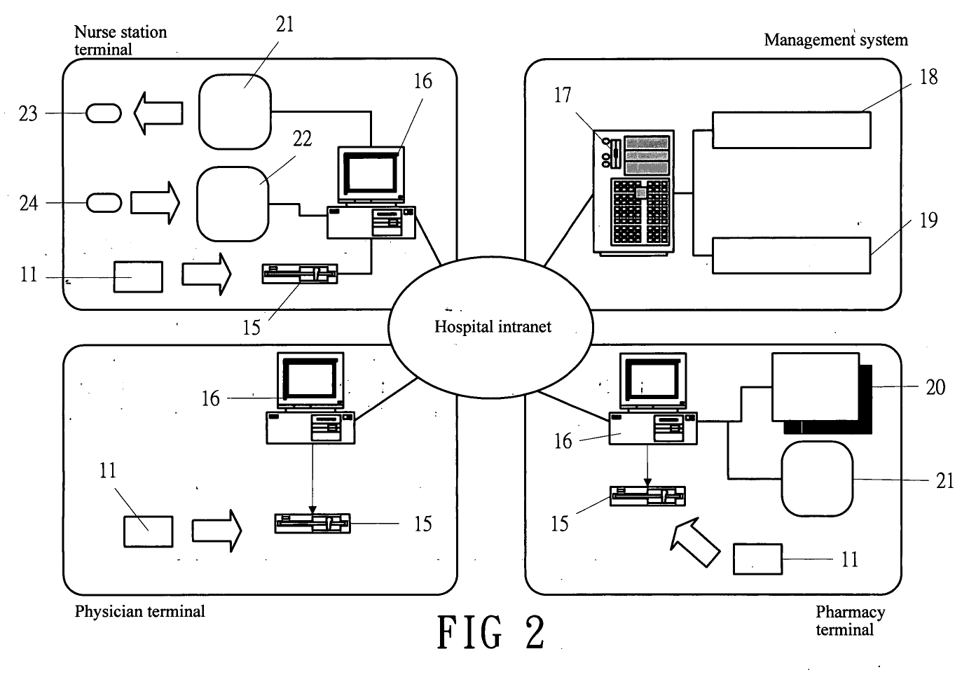

Firstly, please refer to FIGS. 1 and 2. These two figures illustrate the allocation of the invention. The system of invention includes:

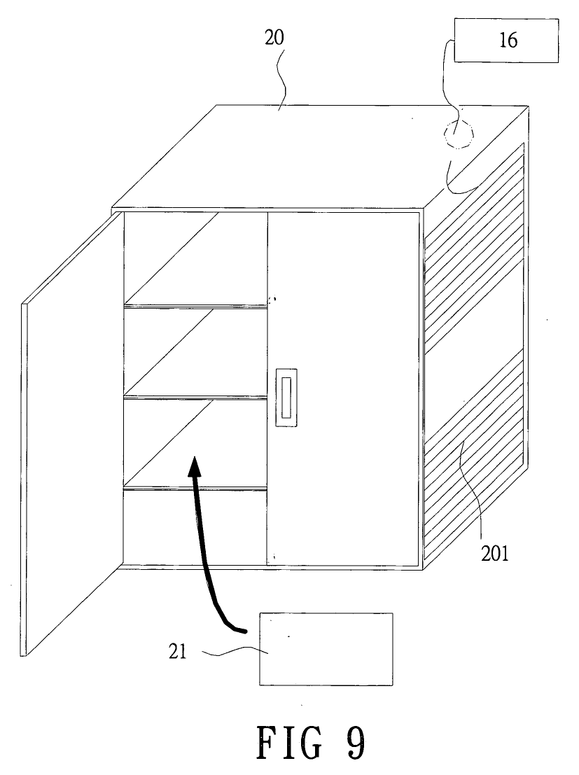

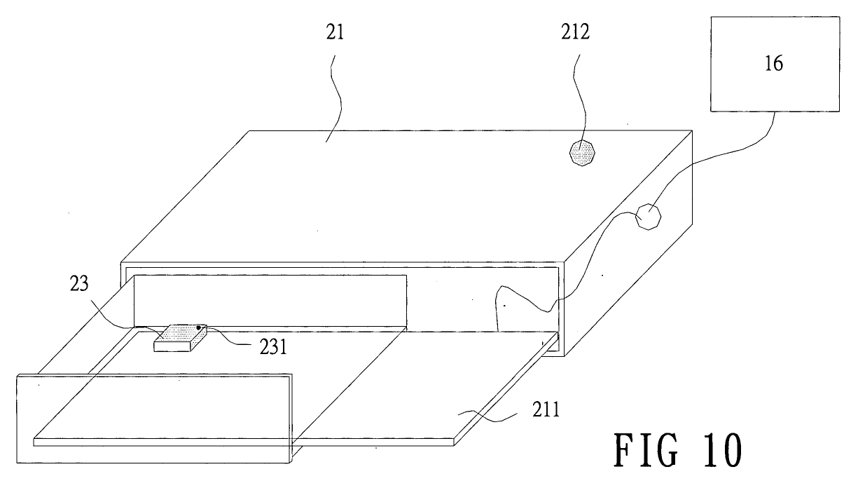

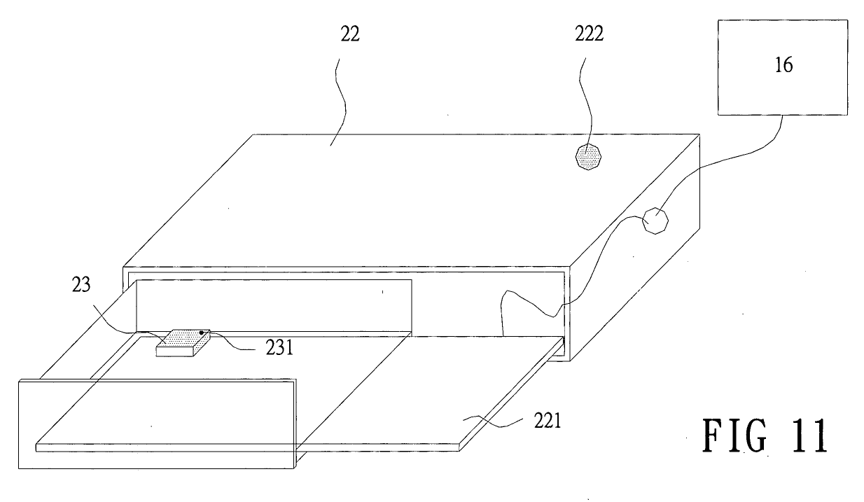

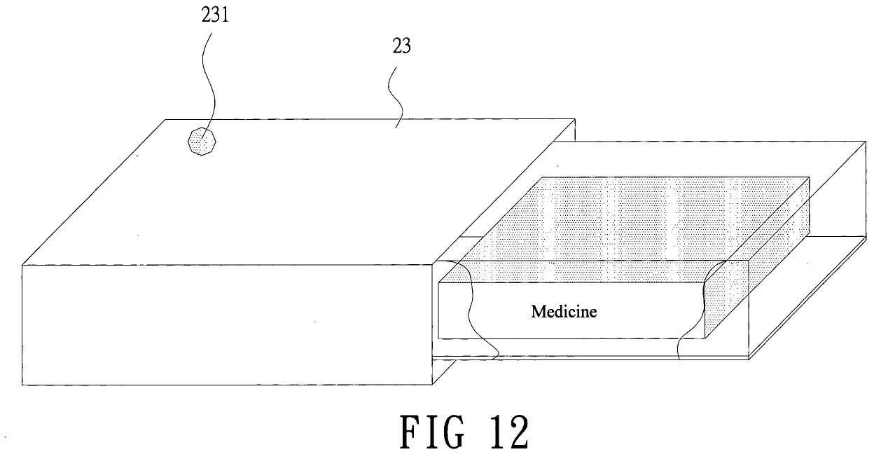

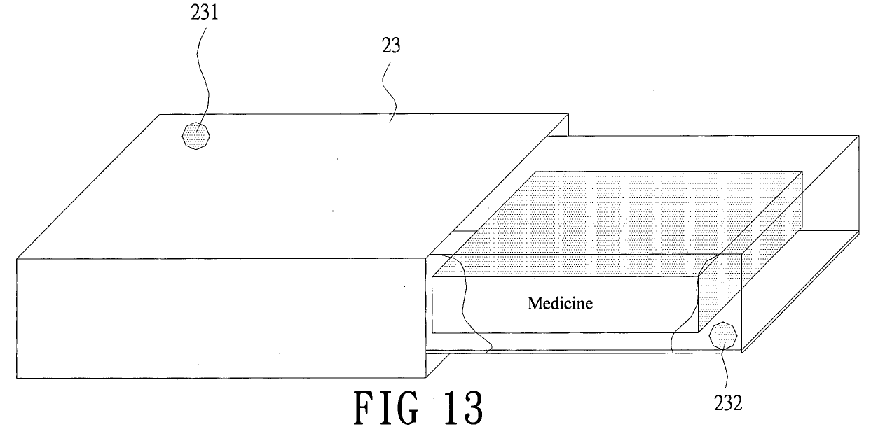

Healthcare Process Card (HPC) of HCA for medical staff 11. The card is provided to physicians, nurse staffs, pharmacist and related medical staffs to proceed with identity authentication, system login and digital signature by a card reader 15 connected to a computer 16.
a patient's identity device 14. This device, an RFID tag storing a non-redundant number, is worn by patients for medical staff to verify patient's identity.
a card reader 15. The reader is connected (linked) to a computer 16 in order to proceed with card reading described previously.
a computer terminal 16. It serves as a medium between the server 17 and medical staffs to handle identity authentication, data retrieving/writing, and the recording of managing process.
a server 17. The server process retrieving/writing, managing and recording of medical information by linked to the computer 16 through hospital intranet.
a database 18. The database is connected to the server 17 and serves to store and to record medicine information.
an alert model 19. It triggers a system alert, gives alarm and generates a record to be stored in the server 17 as a reference to management staffs.
an electronic medicine cabinet 20 linked to the computer 16. The cabinet contains an RFID reader 201 and serves as storage for electronic medicine chest 21 and electronic medicine-reclaiming chest 22. The RFID reader 201 detects the signals from the RFID tags 212 and 213 on electronic medicine chest 21 and electronic medicine-reclaiming chest 22 (Please refer to FIG. 9 for the structure).
an electronic medicine chest 21 linked to the computer 16 and serving as storage for medicine box 23. The chest contains an RFID reader 211- to detect the signal from the RFID tag 231 on a medicine box, and an RFID tag 212- to record the information of the medicine stored in the chest 21 (Please refer to FIG. 10 for the structure).
an electronic medicine-reclaiming chest 22 linked to the computer 16 and serving to reclaim medicine box 23. The chest contains an RFID reader 221 and an RFID tag 222 to record the information of the medicine reclaimed by the chest 22 (Please refer to FIG. 11 for the structure).
a medicine box 23 serving as medicine storage. The box contains an RFID tag 231- to label the medicine information of the medicine in a medicine box, and a triggerable RFID tag 232 attached to the opening of a medicine box. When the box is opened, it simultaneously initiates the triggerable RFID tag 232 to notify the system by giving signal. The triggering device for triggerable RFID tag 232 could be a light-detecting, thin-film, or mechanical switch (Please refer to FIGS. 12 and 13 for the structure).
a medicine box 24 used for medicine storage. The structure is the same as that of the medicine box 23 (Please refer to FIGS. 12 and 13 for the structure).
a portable device 25 linked to the server 17. A portable device 25, could be a cellular phone, a PDA or a laptop, is provided to medical staffs for reading/writing patients' records, medical orders and prescriptions.
an RFID reader 26. It is linked to a computer 16 and a portable device 25 for reading a patient's identity tag 14.

A method to apply RFID and PKI technologies for patient safety requires the following steps:

(a) Taking medicines at pharmacy terminal: a pharmacist logs in the management system to confirm identity, then puts the medicine into a medicine box and stores in an electronic medicine cabinet. The RFID reader in the cabinet collects the renewed medicine information, and then transmits the information to management system. After the pharmacist completes digital signature, the information is written to the database on the management system.

(b) Physician terminal: a physician logs in the management system to confirm identity. He/She then proceeds to prescribe for patient, to give medical order, to give digital signature and to verify that there is no error on prescription and medical order. The nurse staffs will base on the information for retrieving medicine and therapy.

(c) The nurse staff retrieves medicine at nurse station terminal: a nurse staff logs in the management system to confirm identity, download prescription and medical order, and retrieve the medicine from electronic medicine chest according to the prescription.

(d) The nurse staff proceeds with medicine injection at nurse station terminal: a nurse staff retrieves and compares patient's information, gives dose to the patient and verifies the status of medicine injection, and then uploads the information to the management system to be stored in database for price computing, and proceeds with digital signature.

(e) The nurse staff reclaims empty medicine box at nurse station terminal: a nurse logs in the management system to authenticate identity, puts an empty medicine box into an electronic medicine chest and close it. At this moment, the RFID reader collects the changed medicine information, transmits the information to the terminal at nurse station, then the nurse gives digital signature for confirmation. The nurse of next shift verifies if all the empty medicine boxes have been reclaimed and confirms with the management system.

(f) Exchanging empty boxes at pharmacy terminal: a nurse brings the electronic medicine chest to pharmacy and connects it to the computer. The pharmacist and the nurse log in the management to confirm identity. The pharmacist opens the electronic medicine cabinet for exchanging medicines and medicine boxes, and then closes the electronic medicine chest and the cabinet. At this moment, the RFID reader collects the changed medicine information, confirms the changed medicine and its quantity, and transmits the information to pharmacy terminal. After the management system proceeds with comparing of the changed data, it then requires the pharmacist to establish and confirm the relationship between medicine box and electronic medicine chest, and asks digital signature from the pharmacist and the nurse staff for confirmation.

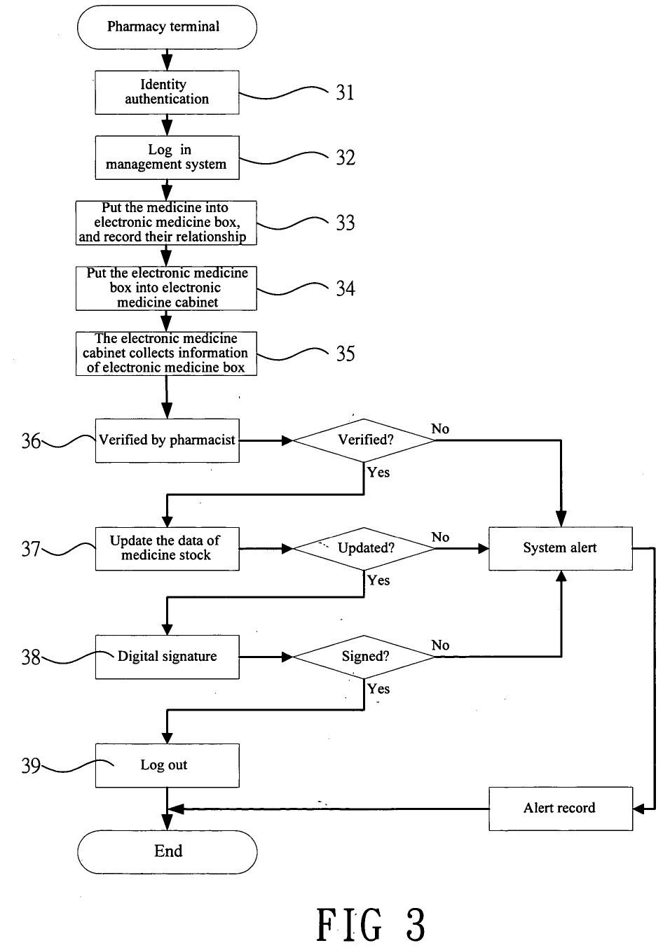

The action flowchart of taking medicine on pharmacy terminal of the invention is illustrated in FIG. 3. Whenever the medicine stock of the hospital is below the safety stock, the management system will give alert to pharmacy staffs to refill medicine through alert model 19 and records this alert in database 18. The detailed procedure is:

Step 31: identity authentication. Pharmacist inserts HPC of HCA for medical staff into card reader 15, through the computer 16 links to the server 17 for verifying the pharmacist's identity.

Step 32: log in management system.

Step 33: put the medicine into the electronic medicine box, record the relation in between. Pharmacist puts the medicines into separate medicine box 23 containing RFID tag 231 and RFID tag 232 based on different requirement, establishes the relationship between medicine and medicine box 23, and uploads the information to database 18.

Step 34: put the electronic medicine box into electronic medicine cabinet. Pharmacist put the medicine box 23 into an electronic medicine cabinet containing an RFID reader 201.

Step 35: the electronic medicine cabinet collects information on electronic medicine box. When the cabinet 20 is closed, the RFID reader 201 collects the updated medicine information, confirms the altered medicine and its quantity, and then transmits the data to pharmacy terminal 16.

Step 36: Verified by Pharmacist. The management system requests the pharmacist to verify the changed medicine information and its quantity. If the verification is not completed in a period of time, the management system will give a system alert to notify the staff and generate a record to store in server 17; if it is completed, then proceed with step 37.

Step 37: Update the data of medicine stock. After completing data upload and information synchronization, the management system will request the pharmacist to proceed with confirmation. If the data uploading or information synchronization is not finished, the management system will give a system alert to notify the staff and generate a record to store in server 17; if it is done, then proceed with step 38.

Step 38: Digital Signature. When the pharmacist completes the verification, the management system then asks the pharmacist for the digital signature for confirming the newly added medicine information. If the action for digital signature is not done, the management system will give a system alert to notify the staff and generate a record to store in server 17; if it is done, then the procedure ends.

Step 39: Log out. The pharmacist logs out of the system.

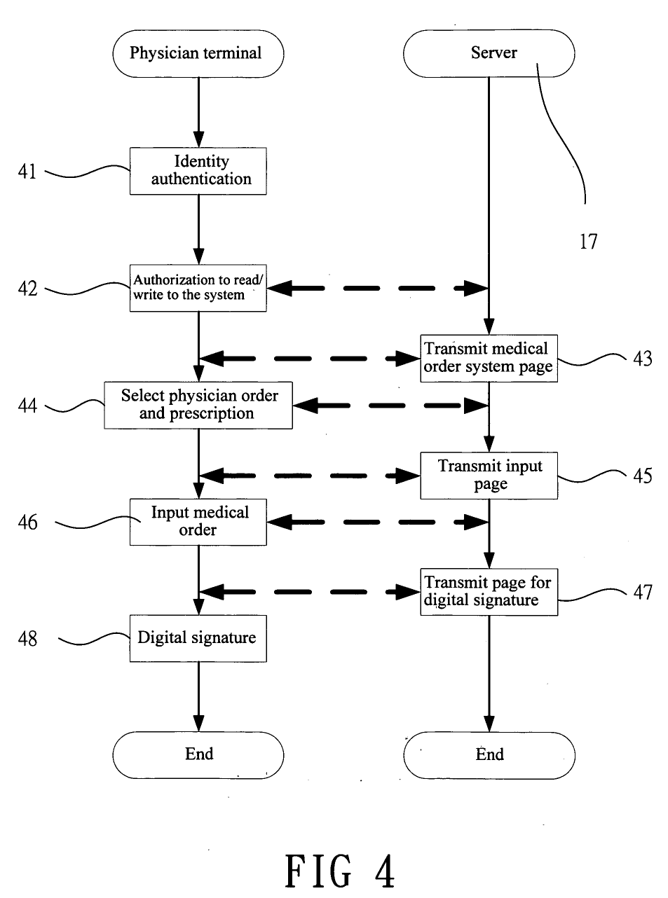

The action flowchart on physician terminal of the invention is illustrated in FIG. 4. The physician terminal stores prescription and related therapy process to the server 17 after diagnosis is done. The nurse staffs retrieve medicine based on the information. The detailed procedure is described below:

Step 41: Identity Authentication. Physician inserts HPC of HCA for medical staff 11 into card reader 15, through the computer 16 links to the server 17 for verifying the physician's identity.

Step 42: Authorization to read/write to the System. The management system gives an order to server 17 for setting up the authorization to read/write data and then proceeds step 43.

Step 43: Transmit medical order system page. The system transmits the medical order system page to physician terminal 15 in clinic.

Step 44: Select physician order and prescription. The page is provided for physician to input the therapy procedure, prescription and physician order based on the diagnosis.

Step 45: Transmit input page.

Step 46: Input medical order. The physician inputs the related information.

Step 47: Transmit page for digital signature.

Step 48: Digital signature. The server 17 transmits a digital signature for the physician to proceed with confirmation.

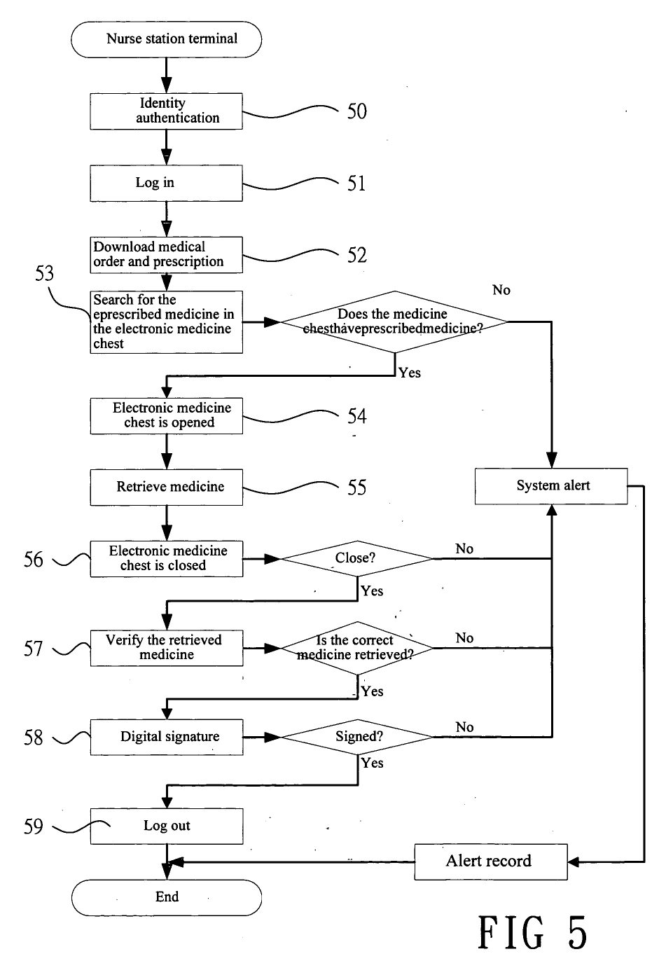

The action flowchart of retrieving medicine on nurse station terminal of the invention is illustrated in FIG. 5. Whenever the prescription is given, the nurse proceeds to retrieve the prescribed medicine. The detailed procedure is:

Step 50: Identity Authentication. The nurse inserts HPC of HCA for medical staff 11 into card reader 15, through the computer 16 links to the server 17 for verifying the nurse's identity.

Step 51: Log in the server 17 to proceed with the procedure of medicine retrieving.

Step 52: Download medical order and prescription. The nurse downloads the medical order and prescription from the server 17 to the nurse station terminal 16 or portable device 25.

Step 53: Search for the prescribed medicine in the electronic medicine chest. Through comparing the downloaded information and the medicine information on the chest 21 at nurse station terminal, the system judges whether chest 21 contains prescribed medicine and enough quantity. If the chest contains prescribed medicine and enough quantity, then the system proceeds to step 54; otherwise, the system will give a system alert to notify the nurse and generate a record stored to the server 17.

Step 54: The electronic medicine chest is opened.

Step 55: Retrieve the medicine.

Step 56: The electronic medicine chest is closed. After the chest 21 is closed, the RFID reader 211 will collect and confirm the information of retrieved medicine and its quantity, and then transmit the information to the terminal 16 at nurse station. If the chest 21 is not closed for a period of time, the system will execute a system alert to notify the nurse and then generate a record stored in the server 17; otherwise, the system proceeds to step 57.

Step 57: Verified the retrieved medicine. The system verifies the retrieved medicine and its quantity with the information from medical order and prescription. If any mismatch happens, the system will execute the system alert to notify the nurse and generate a record to be stored in the server 17; otherwise, the system proceeds to step 58.

Step 58: Digital signature. The system requests the nurse to complete digital signature. If the digital signature is done, then the system proceeds to step 59; otherwise, the system will give alert to notify the nurse and generate a record to be stored in the server 17.

Step 59: Log out. The nurse logs out of the server 17.

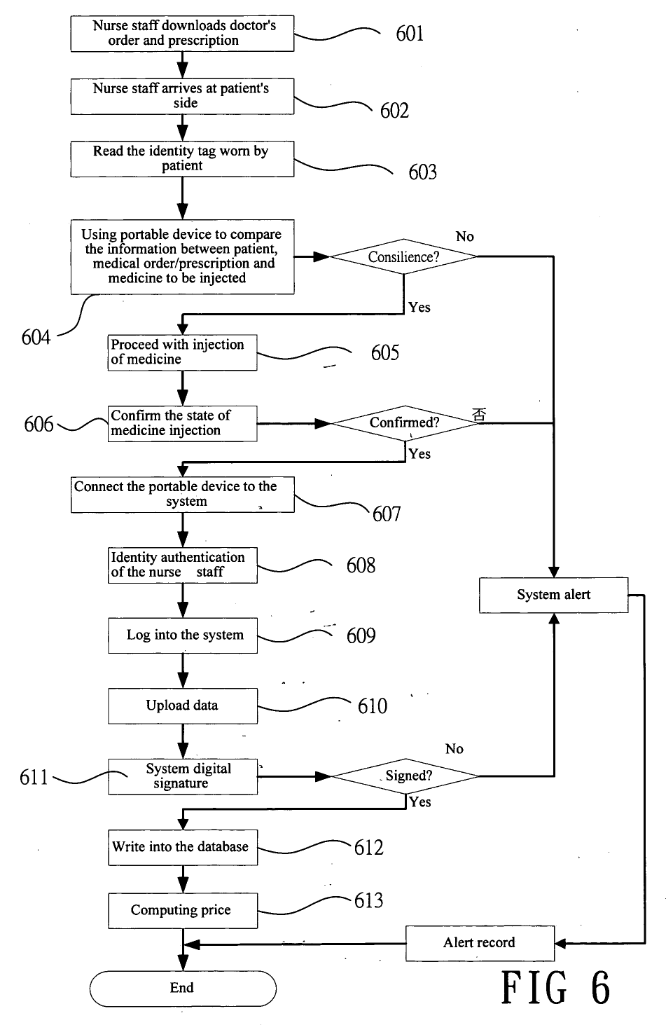

The action flowchart of giving medicine injection on nurse station terminal of the invention is illustrated in FIG. 6. After retrieving the medicine, the nurse proceeds injection of the medicine immediately. This is to avoid improper releasing of medicines. The detailed procedure is:

Step 601: The nurse downloads medical order and prescription from the server 17 to portable device 25.

Step 602: The nurse arrives at the patient's beside.

Step 603: The nurse uses the portable device 25 to read the identity tag 14 worn by patient. The portable device 25 proceeds to compare the information.

Step 604: Using portable device to compare the information between patient, medical order and medicine to be injected. The nurse uses the portable device 25 to confirm the information. There are two kinds of comparison: a) if the patient is identified as that on the medical order, and b) if the medicine on medical order is consistent with the one retrieved. If any mismatch happens, the system will give a system alert to notify the nurse and generate a record stored in the server 17; otherwise, proceeds to step 605.

Step 605: The nurse injects the medicine to patient.

Step 606: Confirm the status of medicine injection. After the completing of the injecting medicine to patient, the nurse needs to make a confirmation on the portable device 25. If the confirmation is not done for a period of time, the system will give a system alert to notify the nurse and generate a record to be stored in the server 17; otherwise, proceeds to step 607.

Step 607: Connect the portable device to the system.

Step 608: Nurse staff confirms identity. The nurse inserts HPC of HCA for medical 11 into card reader 15, through the computer 16 links to the server 17 for verifying the nurse's identity.

Step 609: The nurse logs in the server 17.

Step 610: Upload data. The processed information described above will be uploaded to the server 17 instantly or by batch.

Step 611: Digital signature. The system requests the nurse to complete digital signature. If the digital signature is done, then the system proceeds to step 612; otherwise, the system will give a system alert to notify the nurse and generate a record to be stored in the server 17.

Step 612: Write to database. The system writes the data to the database 18.

Step 613: Price computing. The system computes the price of the injected medicines.

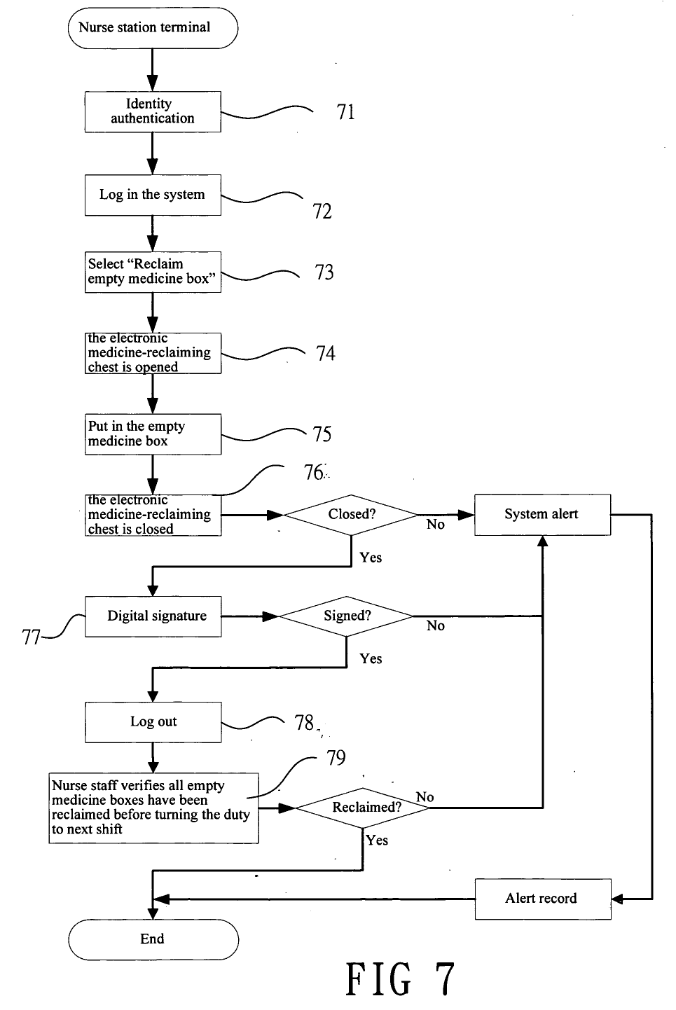

The action flowchart of reclaiming empty medicine boxes on nurse station terminal of the invention is illustrated in FIG. 7. After injecting the medicine to patient, the empty medicine box 23 is put into the electronic medicine-reclaiming chest 22 at nurse station. The detailed procedure is:

Step 71: Identity authentication. The nurse inserts HPC of HCA for medical staff 11 into card reader 15, through the computer 16 links to the server 17 for verifying the nurse's identity.

Step 72: The nurse logs in the server 17.

Step 73: Select “Reclaim empty medicine box”. The nurse selects the empty medicine box 23 to be reclaimed.

Step 74: The electronic medicine-reclaiming chest 22 is opened.

Step 75: put the empty medicine box 23 into the chest 22.

Step 76: The electronic medicine-reclaiming chest 22 is closed. If the chest 22 is not closed for a period of time, the system will give a system alert, notify the nurse and generate a record to be stored in the server 17. If the chest 22 is closed normally, the RFID reader 221 on it collects the information of the medicine box 23, verifies the newly added box and its quantity, transmits the information to the terminal 16 at nurse station and proceeds step 77.

Step 77: Digital signature. After the terminal 16 at nurse station completes the recording of the changed information collected by RFID reader on the medicine-reclaiming chest 22, it then requests the nurse's digital signature for confirming the related actions done with the empty medicine box 24. If the action for digital signature is not completed for a period of time, the system will give a system alert to notify the staff and generate a record to store in server 17; if it is done, then proceeds to step 78.

Step 78: The nurse logs out of the server 17.

Step 79: The nurse staff makes sure every empty medicine box 23 has been reclaimed before turning the duty to next shift. If there is any un-reclaimed medicine box 23, the system will give a system alert to notify the staff and generate a record to store in server 17.

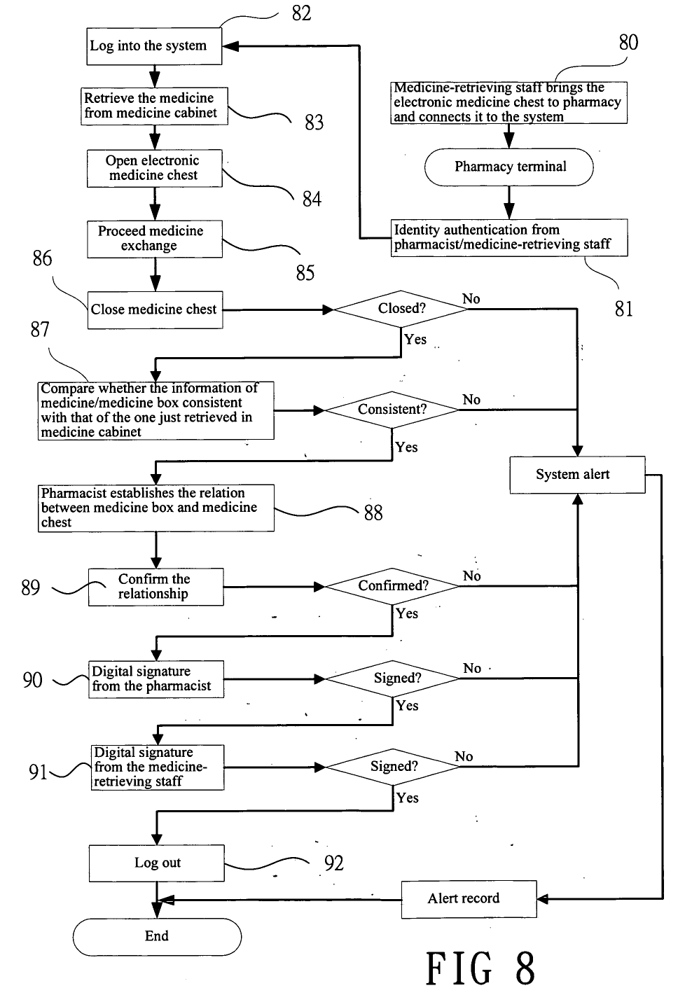

The action flowchart of exchanging empty medicine boxes on pharmacy terminal of the invention is illustrated in FIG. 8. When there is a shortage of medicine at nurse station, the nurse staff brings the electronic medicine-reclaiming chest 22 to the pharmacy to proceed the exchange of medicine box 23 and the empty one 23. The pharmacist in charge verifies the medicine box 23 needs to be exchanged, and links the medicine-reclaiming chest 22 to pharmacy terminal 16 to proceed the action and replenish the medicine. The detailed procedure is:

Step 80: The medicine retrieving staff brings the electronic medicine chest to pharmacy and make connection.

Step 81: Identity authentication of the Pharmacist and the medicine retrieving staff. The staffs insert HPC of HCA for medical staff 11 into card reader 15, through the computer 16 links to the server 17 for verifying their identity.

Step 82: Log in the system.

Step 83: Retrieve the medicine from the medicine cabinet. The pharmacist opens the electronic medicine cabinet 20 and retrieves the requested medicine box 23, then closes the cabinet 20.

Step 84: Open the medicine chest. The pharmacy terminal 16 triggers the opening of the electronic medicine-reclaiming chest 22 brought by the nurse staff.

Step 85: Proceeds medicine exchange. The pharmacist takes the empty medicine box 24 from the opened electronic medicine-reclaiming chest 22, and then put the requested medicine box into it.

Step 86: Close the medicine chest. The staff closes the chest 22. If the chest 22 is not closed for a period of time, the system will give a system alert, notify the staff and generate a record to be stored in the server 17; otherwise, the system proceeds to step 87.

Step 87: Information Matching on medicine box and that of the medicine just retrieved from medicine cabinet. After the medicine chest 22 is closed, the changed information of the medicine box is collected by RFID reader 221, verifies the changed medicine and its quantity, and then transmits the data to pharmacy terminal 16. The pharmacy terminal 16 compares the changed information and quantity of the medicine with that of medicine stock. If there is any inconsistent about the medicine information and quantity, the system will give a system alert, notify the staff and generate a record to be stored in the server 17; otherwise, the system proceeds to step 88.

Step 88: Pharmacist establishes the relationship between medicine box and medicine chest. After the Information Matching as described finished, the management system requests the pharmacist to establish the relationship between medicine box 23 and electronic medicine-reclaiming chest 22.

Step 89: Confirm the relationship. If the action described in step 88 is not completed for a period of time, the management system will give a system alert, notify the staff and generate a record to be stored in the server 17; otherwise, the system proceeds to step 90.

Step 90: The digital signature from the pharmacist. After the pharmacist completes confirming the relationship established between the medicine box 23 and the electronic medicine-reclaiming chest 22, the system requests the digital signature from the pharmacist. If the action for digital signature is not done for a period of time, the system will give a system alert to notify the staff and generate a record to store in server 17; if it is done, then proceeds to step 91.

Step 91: The digital signature from the staff retrieving medicine As soon as the step 90 is completed, the system then requests the digital signature from the staff who retrieves medicine to confirm the actions done for retrieving medicine. If the action for digital signature is not done for a period of time, the system will give a system alert to notify the staff and generate a record to store in server 17; if it is done, then proceeds to step 92.

Step 92: The staffs log out of the server 17.

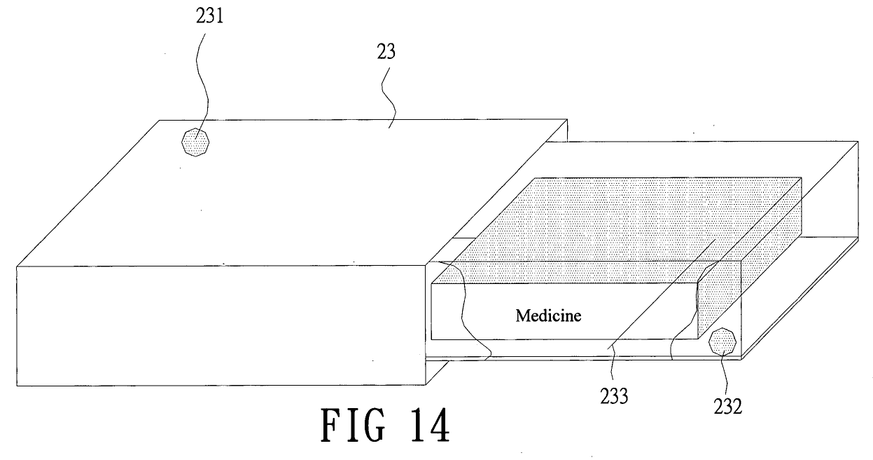

Please also refer to FIG. 14. As what is described above, a triggerable RFID tag 233 could be installed at a proper position in a medicine box 23. When a medicine is put into the box, it contacts with the triggerable RFID tag 233. Taking out of the medicine would trigger the triggerable RFID tag 233, which signals the system. The triggerable RFID tag 233 could use a photo-sensor, a thin-film switch or a mechanical switch to initiate the triggering process.

With the ways described above to manage the status of the medicine, the triggerable RFID tag 232 and 233 are triggered whenever a medicine/or medicine box 23 is taking out of the medicine box 23/or the electronic medicine chest 21. The tags of medicines are sensed and transmit to 1 the system by reader to store the circulation information of a medicine to database through the computer 16. In this way, the invention assists the medicine management staffs of a hospital to control/monitor the status of a medicine, the medicine information, quantity, circulation process or the shortage in hospital; furthermore, it could meet the purpose of patient safety by preventing the misuse of medicine, improperly release of medicines, and making sure the patient is treated with correct medicine.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method applying RFID (Radio Frequency Identification) and PKI (Public Key Infrastructure) technologies for patient safety, comprising the steps of
(a) taking medicines at a pharmacy terminal, wherein the terminal is provided to pharmacists for processing logging into a management system, putting the medicines into a medicine box and then putting the box into an electronic medicine cabinet, collecting changed medicine information of the cabinet through a RFID reader, transmitting data to the management system, giving digital signature, and transmitting the data to store in a database in the management system;
(b) providing a physician terminal to physicians for logging into the management system, prescribing, giving a medical order, giving digital signature, and confirming the prescription and medical order;
(c) retrieving the medicines at a nurse station terminal, wherein the nurse station terminal is provided to nurses for processing logging in and identity authentication, downloading the prescription and the medical order, and retrieving the prescribed medicine from an electronic medicine chest;
(d) injecting the medicine at the nurse station terminal, wherein a nurse reads/compares patient's information, gives the medicine injection to a patient, confirms injection status, uploads information to the management system for storage and computing price, and gives digital signature;
(e) reclaiming empty medicine box at the nurse station terminal, wherein the nurse proceeds logging in and identity authentication, putting the empty medicine box into the electronic medicine chest and closing the empty medicine box, confirming with the third digital signature, and having a next nurse taking over the duty to confirm every empty medicine box is reclaimed;
(f) exchanging the empty medicine box at the pharmacy terminal, further comprising: staff retrieving medicine bringing the electronic medicine chest to a pharmacy and connecting to the pharmacy terminal; the pharmacist and the staff logging in and identity authentication; the pharmacist opening the electronic medicine cabinet for exchanging the medicine and the medicine box; the pharmacist closing the electronic medicine cabinet and the electronic medicine chest; the RFID reader on the electronic medicine cabinet collecting changed information of the medicine and confirming the medicine changed and quantity; uploading data to the pharmacy terminal, the management system matching the changed data, the management system requesting the pharmacist to establish/confirm the relationship between the medicine box and the electronic medicine chest; the system requesting the pharmacy and the staff giving digital signature for confirming an action of medicine exchange.

2. A method as recited in claim 1, wherein the step of (a) further comprising:
processing identity authentication when logging into the management system;
renewing the information of a medicine stock before giving the digital signature; and
logging out of the management system after transmitting the data to store in the database.

3. A method as recited in claim 1, wherein the step of (b) further comprising:
processing identity authentication when logging into the management system;
before giving the digital signature,
giving authorization for reading/writing to the management system;
selecting for giving the medical order and the prescription;
transmitting an input page;
inputting the medical order by the physician inputting related information; and
transmitting a page of digital signature.

4. A method as recited in claim 1, wherein the step of (c) further comprising:
after downloading the medical order and the prescription,
searching for prescribed medicine in the electronic medicine chest;
opening the electronic medicine chest;
after retrieving the medicine,
closing the electronic medicine chest;
verifying the retrieved medicine;
giving digital signature; and
logging out of the management system;

5. A method as recited in claim 1, wherein the step of (d) further comprising:
a nurse staff downloading medical order and prescription;
a nurse staff arriving a patient's bedside;
using the portable device to compare the information between patient, medical order/prescription and medicine to be injected;
injecting medicine;
confirming the status of medicine injection;
connecting the portable device to the system;
identity authentication of a nurse staff,
logging in the system;
uploading the data;
system digital signature;
writing to database; and
computing the price;

6. A method as recited in claim 1, wherein the step of (e) further comprising:
identity authentication; logging in the system;
selecting “Reclaim empty boxes”;
opening the electronic reclaiming medicine chest;
putting in empty the electronic medicine box;
closing the electronic medicine-reclaiming chest;
digital signature;
logging out of the system; and
confirming every empty the medicine box been reclaimed when a nurse staff turns his/her duty to next shift;

7. A method as recited in claim 1, wherein the step of (f) further comprising:
a medicine retrieving staff bringing the electronic medicine chest to pharmacy and connecting it to pharmacy terminal;
identity authentication of the pharmacist and the medicine retrieving staff;
logging in the system;
retrieving required medicine from the electronic medicine cabinet;
opening the electronic medicine chest;
exchanging medicines;
closing the electronic medicine chest;
information matching of medicine/the electronic to know whether medicine box is consistent with the one retrieved from the electronic medicine cabinet;
the pharmacist establishing the relationship between the electronic medicine box and the electronic medicine cabinet;
confirming the relation;
digital signature from the pharmacist;
digital signature from the medicine retrieving staff; and
logging out of the system.

8. A system applying RFID (Radio Frequency Identification) and PKI (Public Key Infrastructure) technologies for patient safety, comprising:
a Healthcare Process Card (HPC) for medical staff, which is provided to physicians, nurses, pharmacists and related medical staffs for actions of an identity authentication and a digital signature through a card reader linked to a computer;
an identifying device worn by a patient, which is an RFID tag containing medical information of the patient for identity and information verification;
the card reader connected to the computer for reading the HPC;
the computer, which works with a server to process the identity authentication of medical staffs, read/write data, and recording supervision procedures;
the server connected to terminals by hospital intranet and responsible for reading/writing, supervising and recording data;
a database connected to the server for storing and recording information of medicines.
an alert model, which triggers a system alert, notifies the situation and generates a record stored in the server as references for management staffs;
an electronic medicine cabinet connected to the computer, which contains RFID readers and is used to store the electronic medicine chest and the electronic medicine-reclaiming chest;
an electronic medicine chest connected to the computer, which contains RFID readers and RFID tags and is used to store the electronic medicine box;
an electronic medicine-reclaiming chest connected to the computer, which contains RFID readers and RFID tags and is used to reclaim the electronic medicine box;
an electronic medicine box for storing medicine, which contains an RFID tag and a triggerable RFID tag;
a portable device connected to the server, which is provided to the medical staffs for reading/writing patient's information, medical order and prescription; and
an RFID reader linked to the computer or the portable device, which is used to read the identifying device worn by patient

9. A system as recited in claim 2, wherein the portable device is a cellular phone, a PDA or a laptop computer.

10. A system as recited in claim 2, wherein the triggerable RFID tag is aphoto-sensor.

11. A system as recited in claim 2, wherein the triggerable RFID tag is a thin-film switch.

12. A system as recited in claim 2, wherein the triggerable RFID tag is a mechanical switch.
